(19) United States
(12) Patent Application Publication
(10) Pub. No.: US 2024/0423300 A1
(43) Pub. Date: Dec. 26, 2024

(54) LIGHTWEIGHT CLOTHING APPARATUS

(71) Applicant: The Haberdash Group, Inc., Valley Stream, NY (US)

(72) Inventors: Joshua Weinberg, Woodmere, NY (US); Ricardo Goldschmidt, Woodmere, NY (US); Elimelech Blumstein, Lawrence, NY (US)

(73) Assignee: The Haberdash Group, Inc., Valley Stream, NY (US)

(21) Appl. No.: 18/752,602

(22) Filed: Jun. 24, 2024

Related U.S. Application Data
(60) Provisional application No. 63/522,697, filed on Jun. 22, 2023.

(51) Int. Cl. A41D 1/02

(52) U.S. Cl. CPC A41D 1/02; A41D 2500/50

(57) ABSTRACT

The present invention discloses a garment comprising at least one component material with a convex layer that features a series of concave structures. Each concave structure may be positioned between 0.5 mm and 10 mm apart from its neighboring concave structure, and may be constructed with fabric of a narrower width compared to the surrounding convex layer. This innovative design provides enhanced flexibility and comfort to the wearer, allowing for improved breathability and movement while maintaining structural integrity. The unique arrangement of concave structures within the convex layer offers a novel approach to garment construction, offering a balance of aesthetics and functionality in modern apparel design.

### FIELD OF THE PRESENT DISCLOSURE

The invention relates generally to a lightweight clothing apparatus. More specifically, the present disclosure is directed to a lightweight clothing apparatus with improved breathability and moisture wicking capabilities.

### CROSS-REFERENCE TO RELATED APPLICATIONS

This application claims the benefit of U.S. Provisional Patent Application No. 63/522,697, filed on Jun. 22, 2023, which is incorporated by reference herein in its entirety.

### INTRODUCTION

Modern day formalwear, namely suits, can trace its origins back to 19th century England. Traditionally, suits have been worn during various formal occasions including weddings and work. However, since the 19th century, suits have become a mainstay in modern attire, and now, are worn in a variety of less formal settings. Notwithstanding the evolution of circumstances in which suits are worn, the actual constitution of the suit itself has not undergone a similar transformation.

Conventionally, the fundamental composition of a suit includes both a suit jacket and a pair of suit pants/trousers, which are made of an identical textile. However, it is not uncommon for a suit to include other components, such as, a vest or waistcoat. Traditionally, suits have been comprised of textiles including cashmere, cotton, linen, silk, synthetic fibers, velvet, and/or wool, wherein wool is the most commonly used textile to fabricate the suits.

Practically, traditional suit textiles, wool in particular, do not provide proper ventilation, making for an uncomfortable wearing experience in warm climates, summer months, and other situations in which the wearer's body increases in temperature. The lack of proper ventilation in conjunction with excessive body heat frequently leads to unmanageable perspiration, which in turn can lead to undesirable body odors. Additionally, traditional suit textiles are rigid and restrict movement, causing further discomfort to those wearing a suit. Furthermore, suits comprised of traditional textiles typically require onerous and uneconomical cleaning procedures such as hand washing and/or dry-cleaning. In addition to the problems arising from hand washing and/or dry-cleaning a suit, traditional suit textiles are prone to wrinkling. Meaning, that someone desiring to wear a suit, must apply heat, via an iron or steam, prior to wearing the suit in order to remove unsightly wrinkles. However, repeated applications of heat to traditional suit textiles can be damaging over long periods of time, which, in conjunction with the difficulties in cleaning a suit, have made traditional suit textiles impracticable for modern use.

As such, there is a need to provide a suit made of textiles capable of reducing suit maintenance and improving both the maneuverability and breathability of the suits. Accordingly, it would be desirable to provide a suit made of an easily maintained textile. Yet further, it would be desirable to provide a suit made of a lightweight and breathable textile, leading to a more pleasant wearing experience during summer months and warmer climates. It would be further desirable to provide a suit made of textiles capable of being adapted to a multitude of situations and able to accommodate a more comfortable wearing experience by reducing the suit's rigidity.

### SUMMARY

This Summary is provided to introduce a selection of concepts in a simplified form that are further described below in the Detailed Description. This Summary is not intended to identify key features or essential features, nor is it intended to limit the scope of the claims included herewith.

Disclosed herein are garments comprising at least one textile material with one or more portions of a plurality of concave structures distributed along the length of the textile material. It is contemplated that the garment design allows for enhanced breathability and comfort by incorporating concave structures within the textile material, promoting air circulation and moisture-wicking properties. Further, the construction of the garment may provide improved ventilation and flexibility, making it suitable for various activities and environments where comfort and performance are essential. Still further, the integration of concave structures within the textile material is contemplated to enhance the overall functionality and wearability of the garment, offering a unique and practical solution for individuals seeking breathable and comfortable clothing options.

Aspects of the present disclosure relate to a garment, including: at least one component material including a convex layer, wherein the convex layer defines a plurality of concave structures, wherein each concave structure is spaced between 0.5 mm and 10 mm from each adjacent concave structure, and wherein each of the concave structures include fabric having a thinner width than the surrounding convex layer.

Aspects of the present disclosure relate to a garment, wherein the at least one textile material is one or more synthetic materials.

Aspects of the present disclosure relate to a garment, wherein the at least one textile material is one or more natural materials.

Aspects of the present disclosure relate to a garment, further including a rigid interlining material disposed on at least a portion of the at least one component material.

Aspects of the present disclosure relate to a garment, wherein the garment is a suit jacket, and wherein the rigid interlining material is disposed on at least a front panel of the suit jacket.

Aspects of the present disclosure relate to a garment, further including one or more stretch panels constructed from a resilient material.

Aspects of the present disclosure relate to a garment, wherein the resilient material is elastane.

Aspects of the present disclosure relate to a garment, wherein the resilient material is a polyurethane elastomer.

Aspects of the present disclosure relate to a garment, wherein the resilient material is a thermoplastic elastomer.

Aspects of the present disclosure relate to a garment, wherein the resilient material is thermoplastic polyurethane.

Aspects of the present disclosure relate to a garment, further including: at layer of hydrophilic polymers disposed at a surface of the at least one component material.

Aspects of the present disclosure relate to a garment, further including: at layer of one or more silicone-based compounds disposed at a surface of the at least one textile material.

Aspects of the present disclosure relate to a garment, wherein the plurality of concave structures form a grid pattern.

Aspects of the present disclosure relate to a garment, wherein the spacing between each of the plurality of concave structures are approximately equal to align both horizontally and vertically to create a uniform lattice-like layout across the at least one component material.

Aspects of the present disclosure relate to a garment, wherein the plurality of concave structures are formed from one or more gaps located between interlaced perpendicular warp and weft threads.

Aspects of the present disclosure relate to a garment, wherein the plurality of concave structures are formed from one or more gaps located between interlocking loops of yarn.

Aspects of the present disclosure relate to a garment, wherein the plurality of concave structures are formed from one or more gaps formed as a lacing material is passed through the at least one textile material.

Aspects of the present disclosure relate to a garment, wherein the plurality of concave structures are formed from one or more gaps located between a loop and a stitch, both the loop and the stitch disposed at one or more sides of the at least one textile material.

Aspects of the present disclosure relate to a garment, wherein the at least one textile material is semitransparent.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an illustration of an embodiment of a top-side view of a plurality of concave structures implemented in a single component material according to aspects of the present disclosure.

FIG. 2 is an illustration of a back-side view of the plurality of concave structures implemented in a single component material of FIG. 1 according to aspects of the present disclosure.

FIG. 3 is an illustration of a partial view of the plurality of concave structures implemented in the single component material of FIGS. 1 and 2 according to aspects of the present disclosure.

FIG. 4 illustrates an embodiment of a suit jacket according to aspects of the present disclosure.

Corresponding reference characters indicate corresponding parts throughout the several views. The exemplifications set out herein illustrate embodiments of the of the present disclosure and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Aspects of the present disclosure may relate to a lightweight clothing apparatus (hereinafter referred to, interchangeably, as the “clothing item” and/or “garment”). The clothing item and/or garment may include, but not be limited to, a jacket, a pair of trousers, and/or a vest. Moreover, the at least one component may further include a shirt, a pair of shorts, and/or an accessory (e.g., a pocket square, tic, bowtie, etc.). In an embodiment, a combination of two or more of the jacket, pair of trousers, vest, shirt, pair of shorts, and/or the accessory may be implemented incorporating a component material 100 as discussed below. Similarly, the component material 100 may be implemented in garments including, but not limited to, Kandura, Jubba, Ghutrah, Keffiych and Abaya utilizing aspects of the present disclosure. For ease of explanation and clarity, the clothing item and/or the garment encompasses wearable articles such as clothing pieces, along with supplementary accessories like bags, purses, backpacks, and fanny packs.

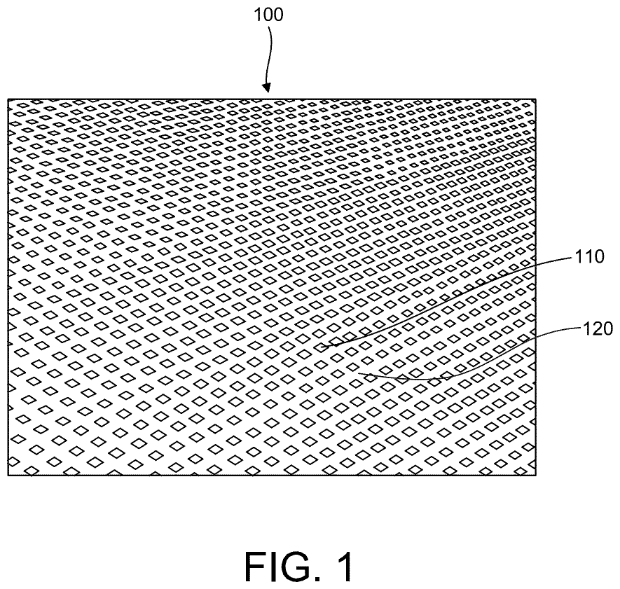

FIGS. 1-3 illustrate a plurality of concave structures 110 and convex layer 120 implemented in a component material 100 for one or more clothing items. In an embodiment, the clothing item includes a jacket comprised of a component material 100 and/or a plurality of component materials (i.e., mesh). In another embodiment, the clothing item includes the pair of trousers, wherein the trousers may be comprised of the component material 100 and/or the plurality of component materials. In a further embodiment, the clothing item includes both the jacket and the pair of trousers. The component material 100 and/or the plurality of component materials may be implemented into a work uniform set, wherein the work uniform set may include a top, a pair of scrub pants, a uniform shirt, a pair of uniform pants, and/or a pair of uniform shorts. In essence, the component material 100 and/or the plurality of component materials may be incorporated into any clothing item where lightweight and breathable properties are desired.

The component material 100 and/or a plurality of component materials 100 may be characterized by a three-dimensional structure featuring a plurality of concave structures 110 and convex layer 120. In one embodiment, the plurality of concave structures 110 characterizing the component material 100 and/or the plurality of component materials may provide semitransparent and breathable properties. The plurality of concave structures 110 may be achieved in various arrangements, as discussed herein, during the creation of the component material 100 and/or the plurality of component materials, by utilizing a component creation process as discussed further below.

The plurality of concave structures 110 may be formed by portions of the component material 100 that are thinner than surrounding thicker portions which form the convex layer 120. As such, the plurality of concave structures 110 may form air pockets which enhance the thermal insulating properties of the component material 100 while the thinner material still allows for breathability.

As shown in FIG. 1, the plurality of concave structures 110 may form diamond shapes. However, other suitable shapes may be achieved as desired. The plurality of concave structures 110 may be laid out in a grid structure as shown. Such structure of the component material 100 may be defined as a warpknit mesh waffle structure. As a non-limiting example, each of the plurality of concave structures 110 may be spaced between 0.5 mm and 10 mm apart. However, other suitable spacings may be used based on desired characteristics as described below.

Depending on the desired properties of the material, each of the plurality of concave structures 110 may be spaced closer together to increase the number of the plurality of concave structures 110 within a given area, or further apart to decrease the number of the plurality of concave structures 110 within the same area. As such, a higher density of concave structures 110 may provide increased breathability, and a lower density of concave structures 110 may provide decreased breathability. It also follows that increasing the density of concave structures 110 will reduce the surface area of the convex layer 120 for that area, and decreasing the density of concave structures 110 will increase the surface area of the convex layer 120 for the same area.

As discussed herein, the component material 100 may be layered with other component materials 100 to impact the properties of a given clothing item. for example, providing additional layers of component material 100 may decrease breathability, but may provide added rigidity (discussed further below) to that specific part of the item. In contrast, less layers of component material 100 may be used to increase breathability and reduce rigidity.

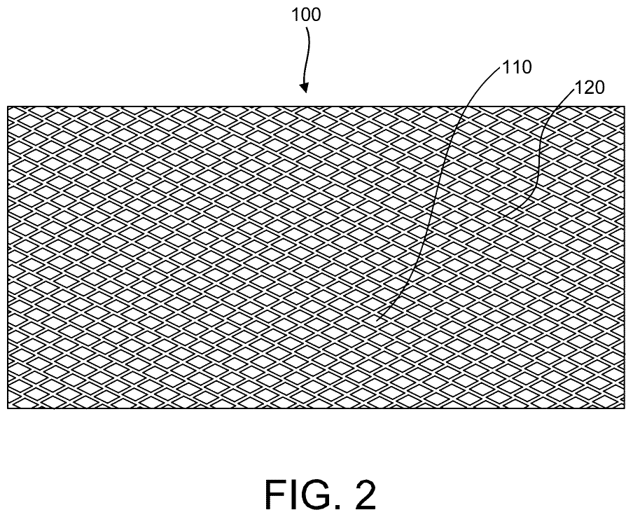

As shown in FIGS. 1 and 2, the plurality of concave structures 110 may be organized in parallel rows and columns, typically referred to as a grid pattern. This grid pattern may be characterized by parallel alignment in both rows and columns, creating a structured layout across the fabric. The parallel arrangement is contemplated to ensure consistency and uniformity in the distribution of the plurality of concave structures 110, resulting in a visually appealing and functional design. In some embodiments, the initial segment of the multiple sections comprising the plurality of concave structures 110 maintains equidistant spacing from a subsequent segment of these sections, resulting in the formation of a grid pattern. In an embodiment, the structured arrangement may be characterized by consistent intervals between adjacent concave structures 110, aligning both horizontally and vertically to create a uniform lattice-like layout across the textile fabric material. In an embodiment, the spacing between plurality of concave structures 110 is between 0.5 mm and 10 mm. However other suitable spacing intervals may be used as desired to achieve properties as discussed herein.

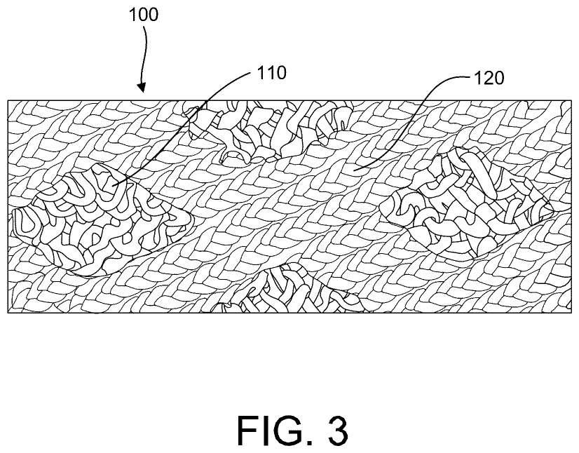

FIG. 3 illustrates the component material 100 of FIGS. 1 and 2 with the plurality of concave structures 110 and convex layer 120 as made up by the warpknit mesh waffle structure. In such an embodiment, the convex layer 120 may be formed from a plurality of rib stitches as shown. However, other stitches, such as a stockinette stitch or warp knitting may be used.

The convex layer 120 may define the plurality of concave structures 110 as described herein. To promote breathability and moisture wicking, the fabric in the plurality of concave structures 110 may be formed by a thinner version of the surrounding convex layer 120. In another embodiment, the plurality of concave structures 110 may include a chaotic weave structure as shown where the fabric is loosely packed in an unorganized manner. Such structure may provide an easy route for air to escape through the component material 100. In a further embodiment where a material comprises two or more layers of the component material 100, the plurality of concave structures 110 may comprise hollow cutouts which pass completely through the component material 100. In such an embodiment, the aforementioned chaotic weave structure maybe disposed between each layer of the component material 100, thus occupying the plurality of concave structures 110.

The component material 100 may be formulated to improve the transfer of heat between a clothing item user (the “user”) and an outside environment. As discussed, in an embodiment, the plurality of concave structures 110 may increase ventilation of the component material 100, which in turn, may increase the efficiency of heat transfer between the user and the outside environment. In another embodiment, at least one ventilation panel may be integrated into the at least one component, wherein the at least one ventilation panel increases the efficiency of heat transfer between the user and the outside environment and/or increases the circulation of air throughout the at least one component. In an embodiment, the plurality of concave structures 110 allows for air to circulate freely throughout the at least one component. The circulation of air may improve breathability and/or moisture wicking capabilities of the at least one component. In yet a further embodiment, the component material 100 and/or the plurality of component materials may increase the breathability and/or moisture wicking capabilities of the component material 100.

The component creation process may employ a fabric interconnection technique, wherein the technique may be at least one of a weaving technique, a knitting technique, a lacing technique, and/or a crocheting technique to create a unique warpknit mesh waffle material. For example, the implementation of gaps within the fabric structure may be achieved through various fabric interconnection techniques. These techniques, including weaving, knitting, lacing, and crocheting, serve as fundamental methods for constructing textiles with specific properties and designs. Weaving involves interlacing warp and weft yarns perpendicular to each other, allowing for the creation of gaps between the threads based on the pattern and density of the weave. Knitting, on the other hand, forms fabric by interlocking loops of yarn, with the size and placement of the loops determining the presence and size of gaps within the fabric. Lacing entails the insertion of cords or threads through existing fabric, creating gaps as the lacing material passes through the fabric layers. Crocheting utilizes a single hook to form loops and stitches, enabling the creation of gaps within the fabric structure by controlling the tension and spacing of the stitches. While these techniques are preferred, alternative techniques may also be employed in the component creation process to achieve specific design objectives or address unique material requirements.

As noted above, the component material 100 and/or the plurality of component materials are constructed from at least one textile material. In some embodiments, the at least one textile material may be comprised of a synthetic material, wherein the synthetic material may include, for example, at least one of polyester, nylon, spandex, polypropylene, polytetrafluoroethylene (“PTFE”), and/or aramid fibers. However, the at least one textile material may be comprised of any suitable synthetic material alternative.

In an embodiment, the at least one textile material may be comprised of a natural material, wherein the natural material may include, for example, at least one of cashmere, cotton, hemp, leather, linen, silk, and/or wool. However, the at least one textile material may be comprised of any suitable natural material alternative.

Additionally, in some embodiments, the textile material may be comprised of a blended material. In an embodiment, the blended material may be comprised of a combination of more than one natural materials. In a further embodiment, the blended material may be comprised of a combination of more than one synthetic materials. In yet a further embodiment, the blended material may be comprised of a combination of one or more natural materials and synthetic materials.

The component material 100 and/or the plurality of component materials may, in some embodiments, improve upon the clothing item's maneuverability. In an embodiment, the component material 100 and/or the plurality of component materials may possess elastic properties by utilizing elastic materials such as clastic polyester, lycra, spandex, elastane, or other elastic material disposed within the at least one component material 100 and/or the plurality of component materials to improve the clothing item's maneuverability.

Moreover, in some embodiments, the component material 100 and/or the plurality of component materials provide increased maneuverability, wherein the maneuverability may be achieved by at least one of a strategically placed stretch panel and a specific construction technique. The aforementioned improvement upon the breathability and/or moisture wicking capabilities of the at least one component may improve a level of comfort the user experiences while wearing the clothing item.

In some embodiments, resilient materials may be utilized for the integration of stretch panels in garments to augment maneuverability. In an example, a resilient material may include, but not be limited to, elastane. Typically, blended with fabrics like cotton, polyester, or nylon, elastane fibers contribute to the creation of stretch panels characterized by superior flexibility and elastic recovery. Moreover, polyurethane (PU) elastomers may be utilized in some embodiments due to their commendable stretch attributes and resistance to abrasion, rendering them suitable for performance-oriented sportswear and activewear. Additionally, thermoplastic elastomers (TPE), comprising materials like styrene-butadiene-styrene (SBS) and thermoplastic polyurethane (TPU), exhibit versatility, durability, and facile processing, and may be utilized in some embodiments. It is contemplated that the resilient materials may be strategically integrated into garments through tailored construction techniques, such as flat-lock seams or paneling, to optimize both freedom of movement and structural integrity.

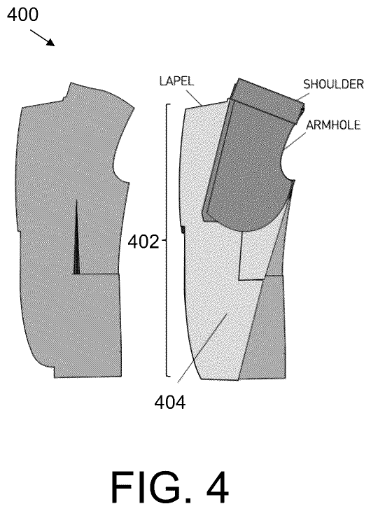

Referring to FIG. 4, the component material 100 may be implanted in suit jackets 400, suit trousers, or other formal attire (e.g., items that include a collar) to increase their breathability and maneuverability. However, previous attempts using mesh fabrics have resulted in jackets and trousers that are visually unappealing, completely transparent, and/or unable to hold the form required for suit articles. As such, it is contemplated that portions of items incorporating the component material 100, such as portions of a suit jacket 400, may need to possess more rigid qualities than the surrounding material. While, as discussed above, increased rigidity may be achieved by layering the component material 100, a rigid interlining material 404 may also be used as exemplified in FIG. 4. For example, the front panel 402 of the suit jacket 400 may incorporate the component material 100, but may also be layered with a rigid interlining material 404 to prevent the suit fabric from sagging due to the component material's 100 elastic properties. Such rigid interlining material 404 may include cotton, silk, or other non-clastic fabrics stitched onto the component material 100. Other portions of the suit jacket 400, such as the sleeves, may not include said rigid interlining material 404 due to the needed maneuverability of such portions and the resulting desire for increased elasticity.

The component material 100 may also be utilized in larger formal wear items that benefit from breathability while requiring portions to possess a level of rigidity. For example, the component material 100 may be utilized in a bekeshe (also referred to as a kapotch), which is a frock coat worn by Hasidic Jews, and by some non-Hasidic Haredi Jews. People who wear a bekeshe, particularly during the summer months, can struggle to stay cool due to the larger profile of the bekeshe. As such, constructing the bekeshe from component material 100 may allow a user to remain cool, reducing the risk of conditions resulting from overheating such as heat stroke. Much like the suit jacket 400, or other formal articles of clothing, rigid interlining material 404 may be used to increase the rigidity of various portions of the bekeshe, such as the front panel, allowing the bekeshe to retain its desired shape.

In some embodiments, the component material 100 may be treated with a clothing item treatment. The clothing item treatment may treat the component material 100 and/or the plurality of component materials to improve breathability of the clothing item. In another embodiment, the clothing item treatment may treat the component material 100 and/or the plurality of component materials to increase moisture wicking capabilities. In a further embodiment, the clothing item treatment may treat the component material 100 and/or the plurality of component materials to make the component material 100 and/or the plurality of component materials resistant to wrinkles. The clothing item treatment may not alter the component material 100 and/or the plurality of component materials. In yet a further embodiment, the clothing item treatment may employ a combination of the aforementioned embodiments.

In some embodiments, the clothing item treatment may comprise various chemical formulations to be utilized in the treatment of the component material 100 to enhance its properties. For example, in an embodiment directed to improving breathability, an example formulation may contain nano-sized particles of substances like titanium dioxide or zeolites. These particles help to create micro-sized pores in the fabric, facilitating better air circulation, thus improving breathability. In one embodiment to enhance moisture-wicking capabilities, the clothing item treatment may comprise hydrophilic polymers such as polyethylene glycol or polyacrylic acid. These polymers attract moisture away from the skin, promoting evaporation and keeping the wearer dry. In an embodiment directed to wrinkle resistance, formulations comprising silicone-based compounds, for example, dimethylpolysiloxane or polysiloxane resins can be applied to the clothing item. These compounds create a flexible, protective layer on the fabric surface, preventing creasing and wrinkling during wear or laundering. Importantly, these treatments can be tailored to specific fabrics and garment types to ensure compatibility and effectiveness. Additionally, combinations of these formulations can be employed to achieve multifunctional enhancements, addressing breathability, moisture-wicking, and wrinkle resistance simultaneously.

It is contemplated that formulations incorporating silicone-based compounds, such as dimethylpolysiloxane or polysiloxane resins, can be employed to render a plurality of component materials resistant to wrinkles. These compounds possess unique properties that enable them to form a flexible and protective layer on the surface of the fabric. This layer acts as a barrier, preventing the fabric from creasing or wrinkling when subjected to folding or compression. Further, polysiloxane resins can cross-link with the fabric fibers, further enhancing their wrinkle-resistant properties by imparting structural stability.

The component material 100 and/or the plurality of component materials may reduce a level of maintenance required to maintain the clothing item when juxtaposed against an article of clothing not comprised of the component material 100 and/or the plurality of component materials. In an embodiment, the component material 100 and/or the plurality of component materials may reduce the level of maintenance by decreasing a need for heat application to remove wrinkles. In a further embodiment, the component material 100 and/or the plurality of component materials may reduce the level of maintenance by allowing the clothing item to be machine washed and/or dried. In yet a further embodiment, the level of maintenance may be reduced by employing a combination of the aforementioned embodiments.

The component material 100 and/or the plurality of component materials may maintain the level of style of articles of clothing not comprised of the component material 100 and/or the plurality of component materials. Moreover, the component material 100 and/or the plurality of component materials may allow for a broader range of designs and/or cuts, wherein the designs and/or cuts are configured to accommodate a plurality of body types.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A garment, comprising:
at least one component material comprising a convex layer,
wherein the convex layer defines a plurality of concave structures,
wherein each concave structure is spaced between 0.5 mm and 10 mm from each adjacent concave structure, and
wherein each of the concave structures include fabric having a thinner width than the surrounding convex layer.

2. The garment of claim 1, wherein the at least one textile material is one or more synthetic materials.

3. The garment of claim 1, wherein the at least one textile material is one or more natural materials.

4. The garment of claim 1, further including a rigid interlining material disposed on at least a portion of the at least one component material.

5. The garment of claim 4, wherein the garment is a suit jacket, and wherein the rigid interlining material is disposed on at least a front panel of the suit jacket.

6. The garment of claim 1, further including one or more stretch panels constructed from a resilient material.

7. The garment of claim 6, wherein the resilient material is elastane.

8. The garment of claim 6, wherein the resilient material is a polyurethane elastomer.

9. The garment of claim 6, wherein the resilient material is a thermoplastic elastomer.

10. The garment of claim 6, wherein the resilient material is thermoplastic polyurethane.

11. The garment of claim 1, further comprising:
at layer of hydrophilic polymers disposed at a surface of the at least one component material.

12. The garment of claim 1, further comprising:
at layer of one or more silicone-based compounds disposed at a surface of the at least one textile material.

13. The garment of claim 1, wherein the plurality of concave structures form a grid pattern.

14. The garment of claim 13, wherein the spacing between each of the plurality of concave structures are approximately equal to align both horizontally and vertically to create a uniform lattice-like layout across the at least one component material.

15. The garment of claim 1, wherein the plurality of concave structures are formed from one or more gaps located between interlaced perpendicular warp and weft threads.

16. The garment of claim 1, wherein the plurality of concave structures are formed from one or more gaps located between interlocking loops of yarn.

17. The garment of claim 1, wherein the plurality of concave structures are formed from one or more gaps formed as a lacing material is passed through the at least one textile material.

18. The garment of claim 1, wherein the plurality of concave structures are formed from one or more gaps located between a loop and a stitch, both the loop and the stitch disposed at one or more sides of the at least one textile material.

19. The garment of claim 1, wherein the at least one textile material is semitransparent.
